(19) United States
(12) Patent Application Publication
(10) Pub. No.: US 2026/0218852 A1
(43) Pub. Date: Jul. 30, 2026

(54) GREEN WALL BRACKET SYSTEM HAVING INTERCHANGEABLE SUPPORT MEMBERS

(71) Applicant: Vertically Green Inc., Glenview, IL (US)

(72) Inventor: Kurt Z. Horvath, Glenview, IL (US)

(73) Assignee: Verticallly Green Inc., Glenview, IL (US)

(21) Appl. No.: 19/396,686

(22) Filed: Nov. 21, 2025

Related U.S. Application Data
(60) Provisional application No. 63/750,810, filed on Jan. 29, 2025.

(51) Int. Cl. F16M 13/02

(52) U.S. Cl. CPC F16M 13/022

(57) ABSTRACT

A bracket system mountable to a green wall metal support grid having a plurality of horizontal grid wires comprises a bracket stem and a support member. The bracket stem has a base with one or more wire receiving openings and a male protrusion. The support member has a female socket. The bracket stem is mounted to the metal support grid by receiving grid wires into one or more of the grid wire receiving openings and the support member is secured to the bracket stem by receiving the male protrusion into the female socket. The stem base preferably includes an upper grid wire receiving hook opening and a lower grid wire receiving slot, the male protrusion is preferably trapezoidal or dovetail-shaped, and the female socket is preferably integrally formed within the perimeter side surface of the support member.

### BACKGROUND OF THE INVENTION

### 1.Field of the Invention

The present invention relates to bracket systems which are mountable to green walls. More particularly, the present invention is directed to a bracket system which is mountable to the metal support grid of a green wall and includes interchangeable support members which are adapted to receive and/or support various articles such as, for example, beer bottles, soda cans, wine glasses, candles, shelves, signage, etc.

### Background

Green walls are architectural features which have been designed to support plants or other greenery/vegetation for aesthetic or other purposes. The vegetation of a green wall is typically supported by a metal support grid comprising a plurality of regular spaced horizontal wires and a plurality of regularly spaced vertical wires. The horizontal and vertical wires are typically secured together by, for example, welding, and are secured to and supported by a perimeter frame.

In many cases, it is desirable to be able to mount articles to a green wall. For example, it may be desirable to mount a cupholder to a green wall in a bar or restaurant or to mount a sign plaque to a green wall in a retail business. There are known devices for mounting articles to metal grid structures. See, e.g., Cousins, U.S. 4,340,144; Lehr et al., EP 567,804; and Thalenfeld, U.S. 5,887,731.

Nevertheless, a need exists for an improved bracket system which can be mounted to the metal support grid of a green wall and includes interchangeable support members which can be easily connected to and disconnected from the bracket system for receiving and/or supporting various articles such as, for example, beer bottles, soda cans, wine glasses, candles, shelves, signage, etc.

### SUMMARY OF THE INVENTION

The present invention is direct to a bracket system which is mountable to a green wall metal support grid having a plurality of horizontal grid wires. The bracket system comprises a bracket stem and a support member. The bracket stem has a base with one or more wire receiving openings and a male protrusion. The support member has a female socket. The bracket stem is mounted to the metal support grid by receiving grid wires into one or more of the grid wire receiving openings and the support member is secured to the bracket stem by receiving the male protrusion into the female socket.

Preferably, the stem base includes an upper grid wire receiving hook opening and a lower grid wire receiving slot. Yet more preferably, the lower grid wire receiving slot includes one or more retaining ridges for capturing a grid wire therein.

Preferably, the support member includes a perimeter side surface and the female socket is integrally formed within the perimeter side surface or the support member includes a pair of socket side walls extending from the perimeter side surface and a socket cap shelf extending between the socket side walls, and the female socket is defined between the perimeter side surface, the socket side walls, and the socket cap shelf.

Preferably, the male protrusion is trapezoidal or dovetail-shaped and the bracket stem and the support members are constructed from a plastic or resin material.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIG. 1 is a perspective view of a bracket system constructed in accordance with the principles of the present invention mounted to a green wall;

FIG. 2 is a perspective view of the bracket system and green wall shown in FIG. 1 wherein a portion of the vegetation mounted to the green wall has been removed to show the metal support grid thereunder;

FIG. 3A is a side elevation view of the bracket system and metal support grid shown in FIG. 2;

FIG. 3B is a cross-section view of the bracket system and metal support grid taken along the line 3B-3B shown in FIG. 3A;

FIG. 4A is a perspective view of the bracket stem shown in FIGS. 1-3;

FIG. 4B is a side elevation view of the bracket stem;

FIG. 4C is a top plan view of the bracket stem;

FIGS. 4D and 4E are magnified detail views of circled Detail 4D and circled Detail 4E showing the upper wire receiving hook opening and the lower wire receiving slot of the bracket stem;

FIG. 5A is a bottom perspective view of the cup-shaped support member shown in FIGS. 1-3;

FIG. 5B is a side elevation view of the cup-shaped support member;

FIG. 5C is a bottom end view of the cup-shaped support member;

FIG. 5D is a magnified detail view of circled Detail 5D showing the support member female socket;

FIG. 6A is a bottom perspective view of a dish-shaped support member constructed in accordance with the principles of the present invention;

FIG. 6B is a side elevation view of the dish-shaped support member;

FIG. 6C is a bottom end view of the dish-shaped support member;

FIG. 6D is a magnified detail view of circled Detail 6D showing the support member female socket;

FIG. 7 is a partially exploded side elevation view showing the bracket stem being mounted to the metal support grid;

FIG. 8 is a partially exploded side elevation view illustrating the support member being mounted to the bracket stem;

FIG. 9 is a perspective view of an embodiment of the bracket system wherein the support member is dish-shaped for receiving and/or supporting an article such as a candle;

FIG. 10 is a perspective view of an embodiment of the bracket system wherein the support member is collar-shaped for receiving and/or supporting an article such as a wine glass;

FIG. 11 is a perspective view of an embodiment of the bracket system wherein the support member is a vertical panel having mounting holes for mounting, for example, signage to the green wall; and

FIG. 12 is a perspective view of an embodiment of the bracket system wherein the support member is a vertical panel having a mushroom-shaped protrusion for hanging articles from the green wall.

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

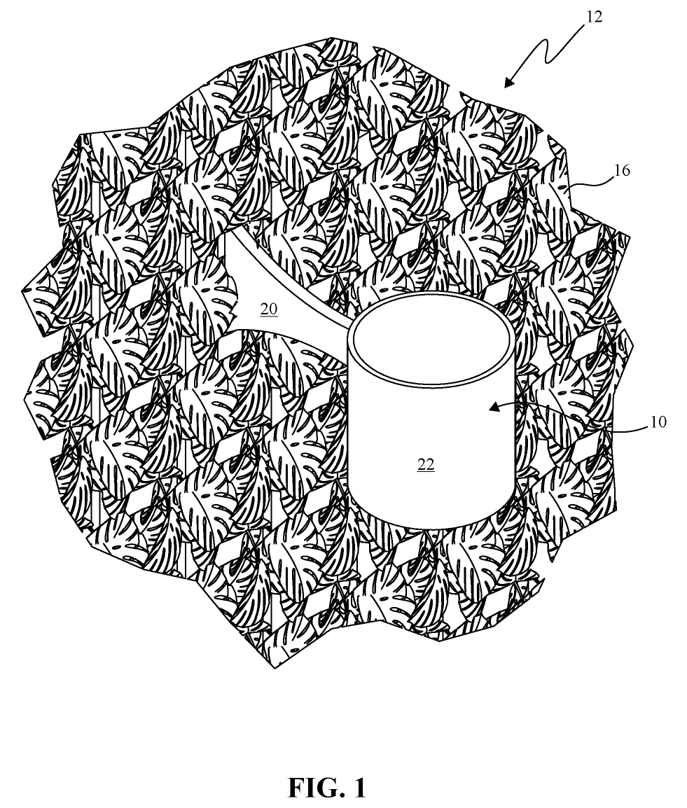

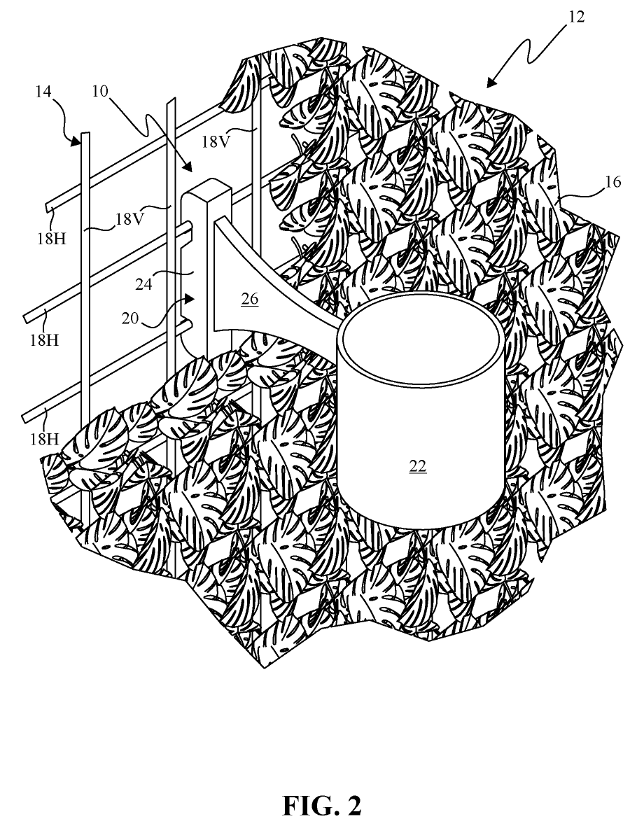

A bracket system 10 constructed in accordance with the principles of the present invention is shown in FIGS. 1-3 and 8-12. The bracket system 10 is adapted to be mounted to a green wall 12 for supporting various articles such as, for example, beer bottles, soda cans, wine glasses, candles, shelves, signage, etc. As best seen in FIGS. 2 and 9-12, a green wall 12 typically includes a metal support grid 14 and vegetation 16 such as, for example, ferns, ivies, philodendrons, pothos, and other plant species which cling to or are supported by the metal support grid 14. The metal support grid 14 is formed from a plurality of regularly spaced horizontal wires 18H and a plurality of regularly spaced vertical wires 18V which are secured together, for example, by welding, and are supported by a frame (not shown).

The bracket system 10 comprises a bracket stem 20 and one or more interchangeable support members 22 which can be provided in a variety of shapes, sizes and configurations (see FIGS. 1, 2, and 9-12). The bracket stem 20 includes a base 24 which is adapted to couple to the metal support grid 14, a support arm 26 which extends from the base 24 out through the green wall vegetation 16, and a male protrusion 28 which extends from the terminal end 26te of the support arm 26. The support members 22 include female sockets 30/100 and are adapted to be selectively and interchangeably mounted to the bracket stem 20 by slidingly receiving and capturing the male protrusion 28 within the female socket 30/100 of the selected support member 22.

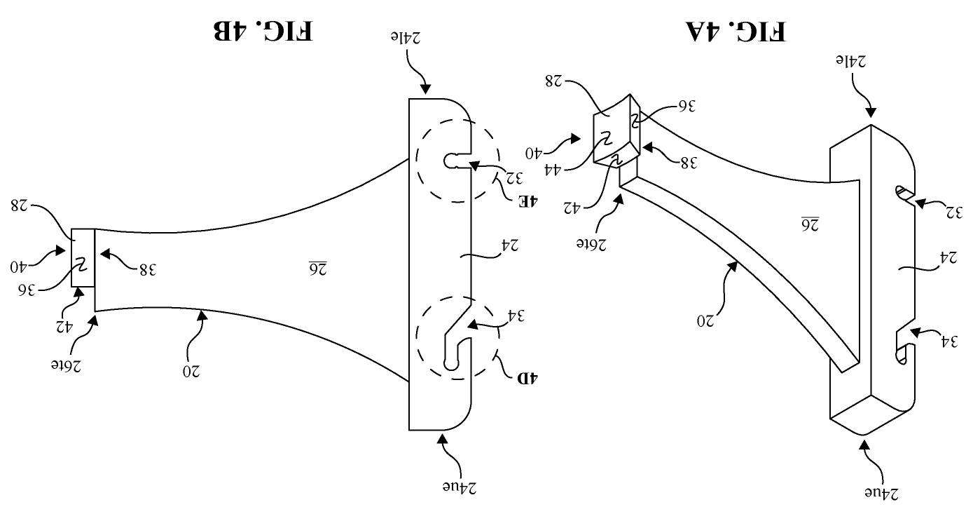

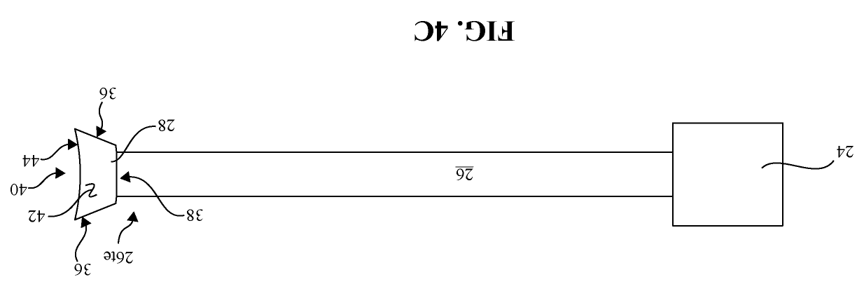

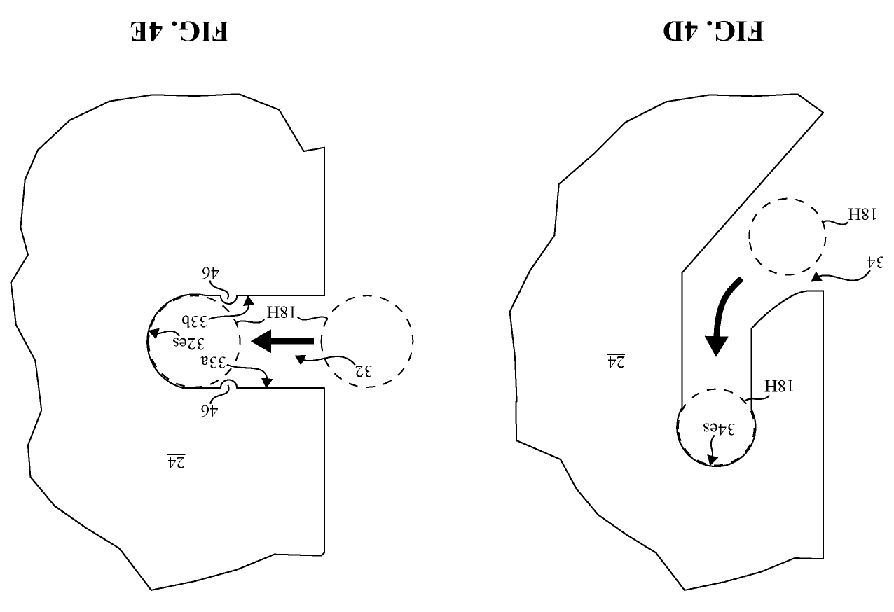

As best seen in FIGS. 4B,4D, and 4E, the bracket stem base 24 includes a lower, wire receiving slot 32 and an upper, wire receiving hook opening 34 which are adapted to engage a pair of adjacent grid wires 18H for coupling the bracket stem 20 thereto. The lower wire slot 32 extends perpendicularly into the base 24 adjacent to the base lower end 24le and includes a semi-cylindrical slot end surface 32es which is adapted to engage a grid wire 18H. The upper hook opening 34 extends into the base 24 adjacent to the base upper end 24ue and angles upwardly away from the lower wire slot 32. The upper hook opening 34 also includes a semi-cylindrical end surface 34es which is adapted to engage a grid wire 18H.

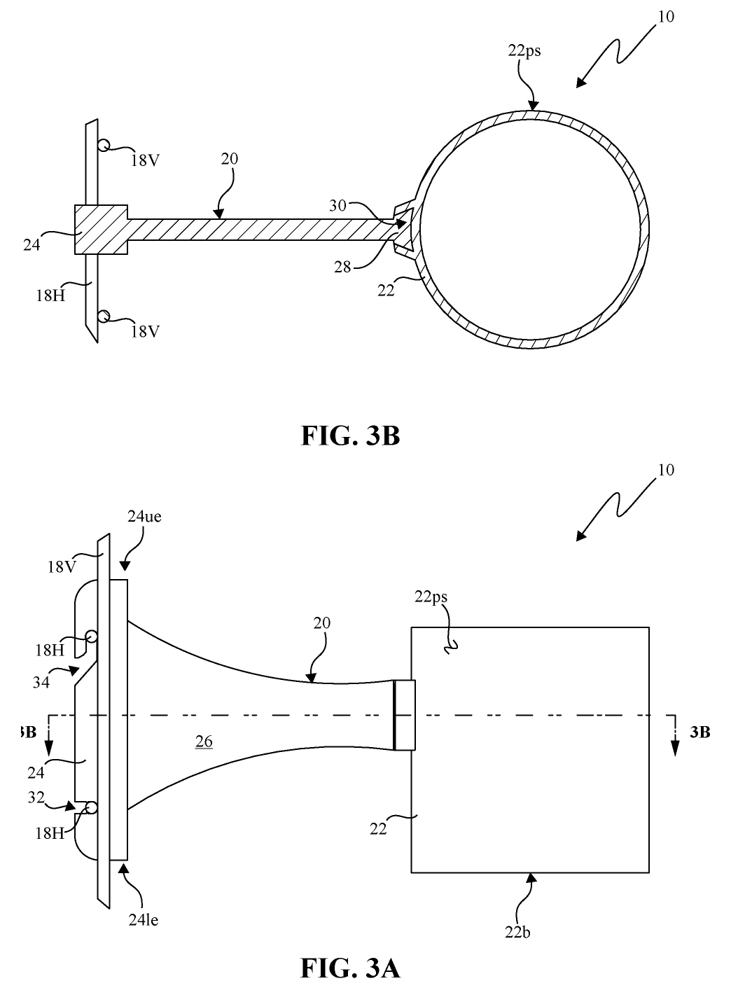

The support arm 26 extends from the base 24 opposite the lower wire slot 32 and upper hook opening 34 and the male protrusion 28 extends from the support arm terminal end 26te away from the base 24. As best seen in FIGS. 3B and 4C, the male protrusion 28 is preferably trapezoidal or “dovetail”-shaped. The dovetail-shaped male protrusion 28 includes tapered protrusion side surfaces 36 which taper outwardly from a narrower, protrusion trailing end 38 to a wider, protrusion leading end 40. The male protrusion 28 also includes a planar protrusion top surface 42 and a concave leading end surface 44.

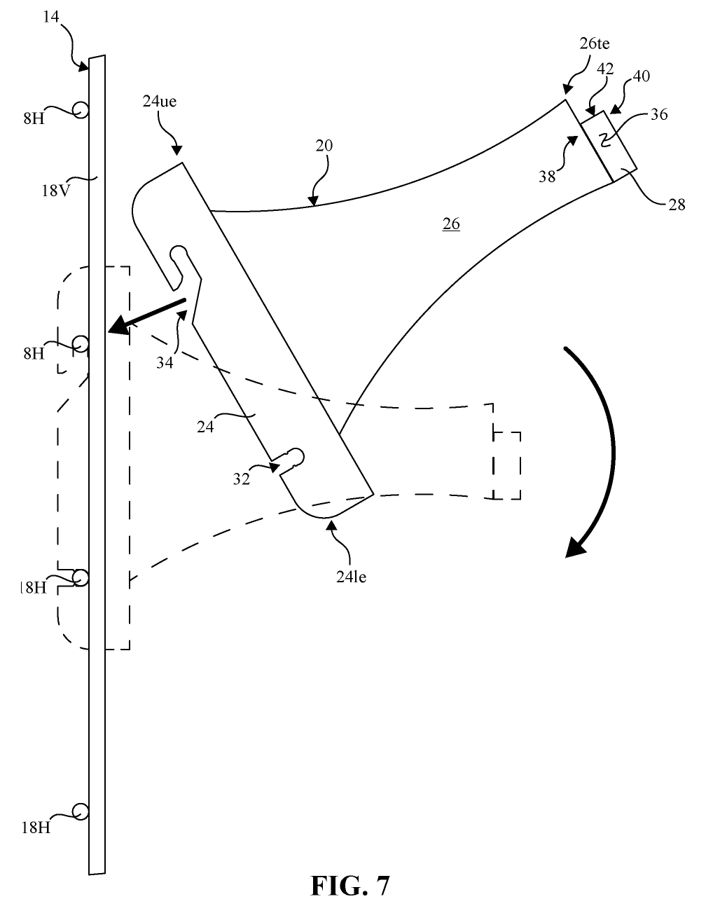

As illustrated in FIG. 7, the bracket stem 20 is mounted to the metal support grid 14 by lowering the bracket stem 20 at an angle towards and receiving an upper horizontal grid wire 18H into the upper hook opening 34 until the upper grid wire 18H engages the hook opening end surface 34es. The bracket stem 20 is then rotated downwardly toward the support grid 14 and an adjacent lower grid wire 18H is received into the lower wire slot 32 and engages the slot end surface 32es. As should now be appreciated, the bracket stem 20 is essentially a cantilever arm which is secured to the green wall metal support grid 14 by receiving the upper and lower grid wires 18H into the upper hook opening 34 and the lower wire slot 32.

Preferably, the lower wire slot 32 includes a pair of semi-cylindrical retaining ridges 46 which extend inwardly from the slot side surfaces 32a, 32b and are adapted to capture the lower grid wire 18H within the slot 32. (See FIG. 4E). Specifically, as the lower grid wire 18H traverses through the lower wire slot 32, the retaining ridges 46 are configured to elastically compress to allow the wire 18H to slide therebetween. This compression subjects the retaining ridges 46 to compressive and tensile/expansive forces and thereby stores elastic potential energy. Once the lower wire 18H slides past the retaining ridges 46 is seated against the slot end surface 32es, the stored elastic potential energy causes the retaining ridges 46 to return to their original shape for thereby capturing the lower wire 18H between the retaining ridges 46 and the slot end surface 32es.

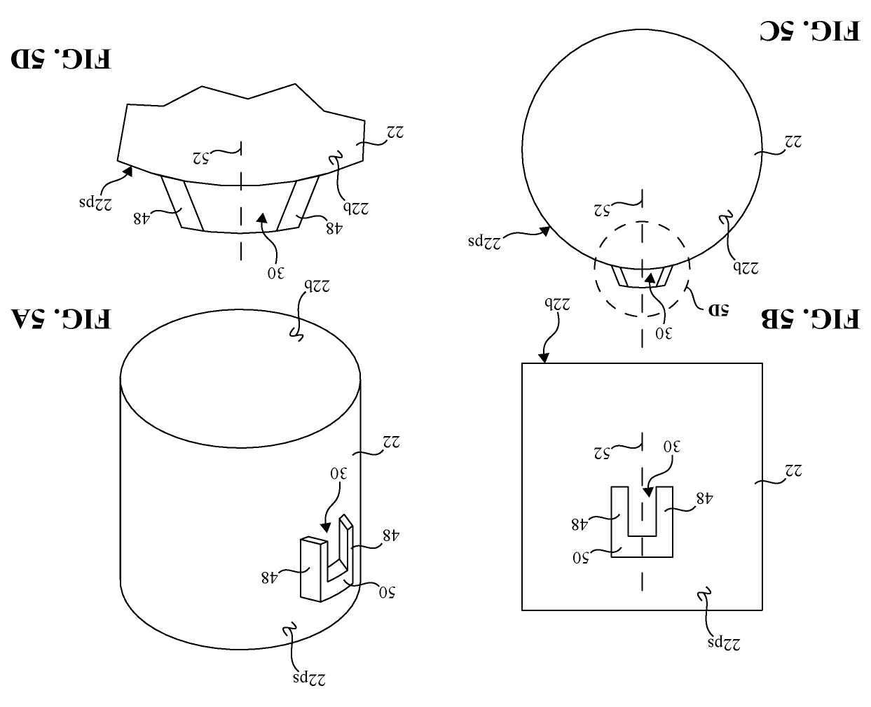

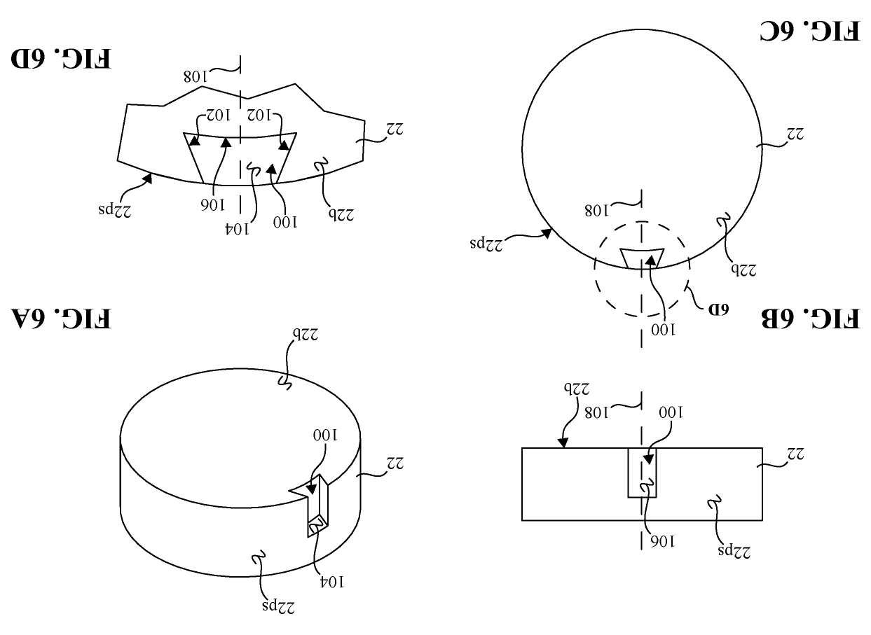

As previously mentioned, the support members 22 include female sockets 30/100 which are configured to slidingly receive and capture the male protrusion 28 for securing the support members 22 to the bracket stem 20. In one embodiment (FIGS. 5A-D), a female socket 30 is defined by a pair of socket side walls 48 and a socket cap shelf 50 which extend from the perimeter side surface 22ps of the support member 22. The socket side walls 48 extend from the perimeter side surface 22ps of the support member 22 and taper inwardly towards a vertical midplane (illustrated in FIGS. 5B-D by line 52) to match the taper of the male protrusion side surfaces 36. The socket cap shelf 50 extends from the perimeter side surface 22ps between the upper ends of the socket side walls 48 and encloses the upper end of the female socket 30. When the male protrusion 28 is slidingly received into the female socket 30, it is captured between the socket walls 48, the socket cap shelf 50, and the support member perimeter side surface 22ps with the protrusion side surfaces 36 engaging the socket walls 48, the protrusion end surface 44 engaging the support member perimeter side surface 22ps, and the protrusion top surface 42 engaging the socket cap shelf 50.

In another embodiment (FIGS. 6A-D), a female socket 100 is integrally formed by molding, machining, or otherwise cutting or forming the female socket 100 into the perimeter side surface 22ps of a support member 22. The integrally formed female socket 100 extends through the perimeter side surface 22ps and the bottom surface 22b of the support member 22 and includes a pair of tapered side surfaces 102, a socket end surface 104, and a curved abutment surface 106. Like the socket side walls 48, the tapered side surfaces 102 taper inwardly towards a vertical midplane (illustrated in FIGS. 6B-D by line 108) to match the taper of the male protrusion side surfaces 36. When the male protrusion 28 is slidingly received into the female socket 100, it is captured between the socket side surfaces 102, the socket end surface 104, and the curved abutment surface 106 with the protrusion side surfaces 36 engaging the socket side surfaces 102, the protrusion end surface 44 engaging the curved abutment surface 106, and the protrusion top surface 42 engaging the socket end surface 104.

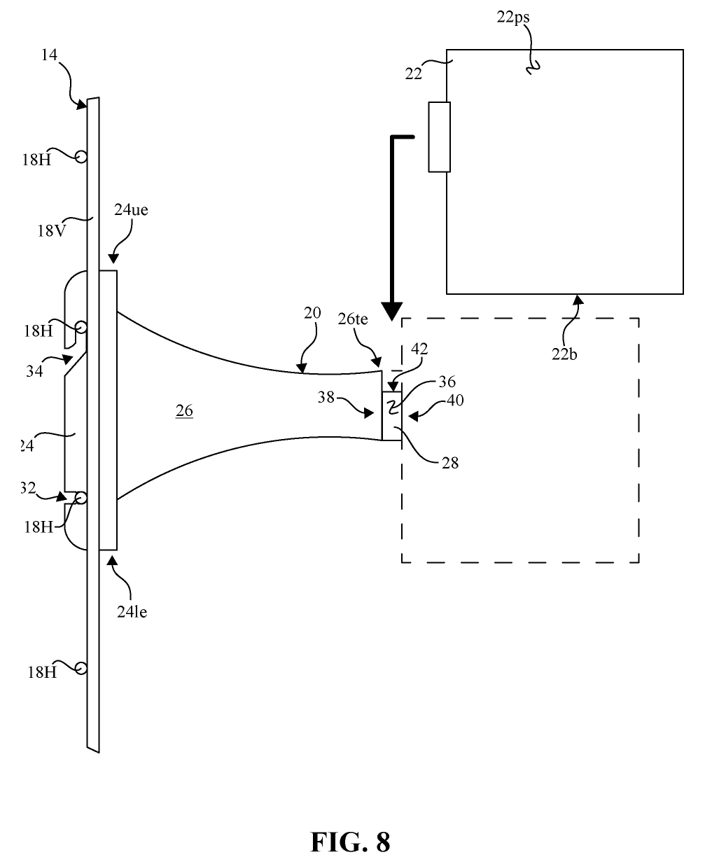

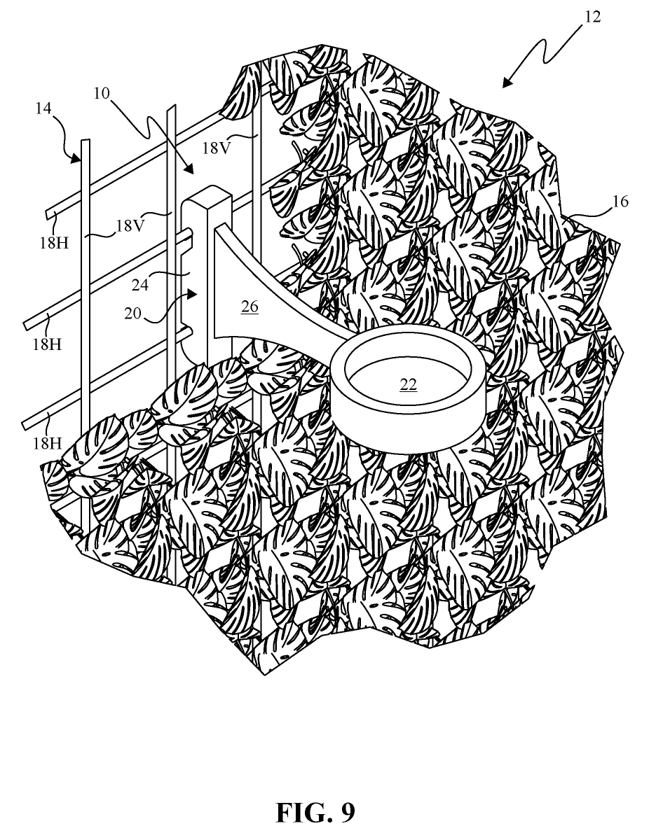

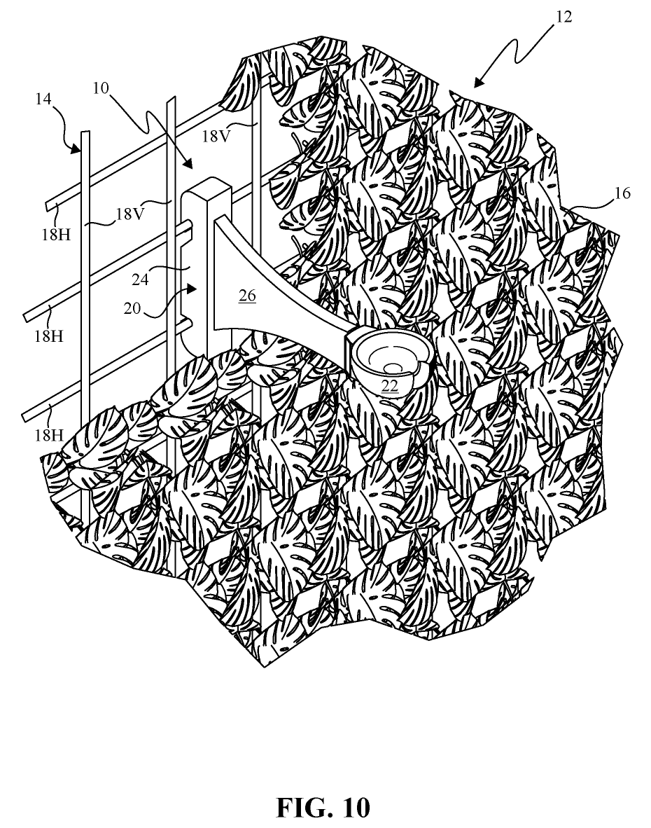

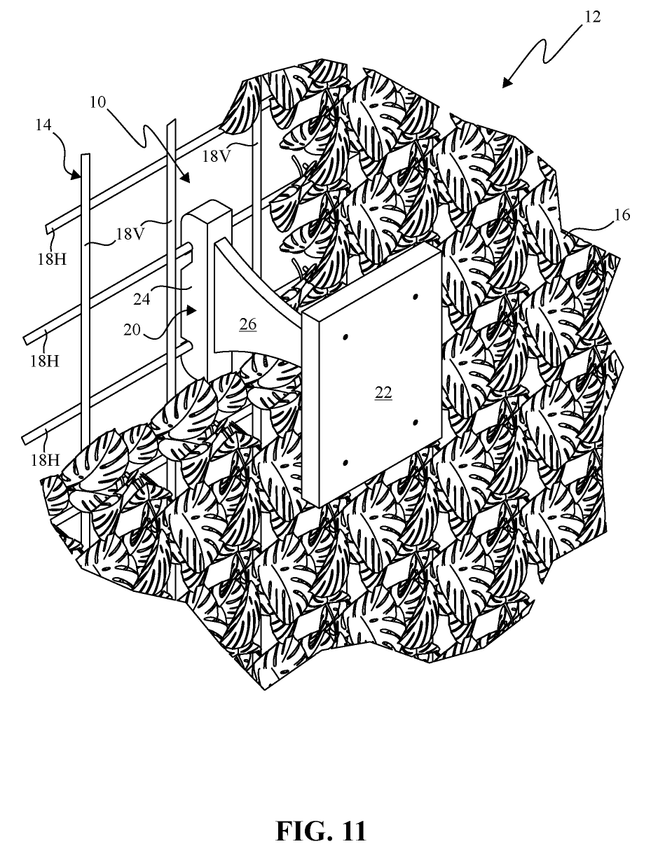

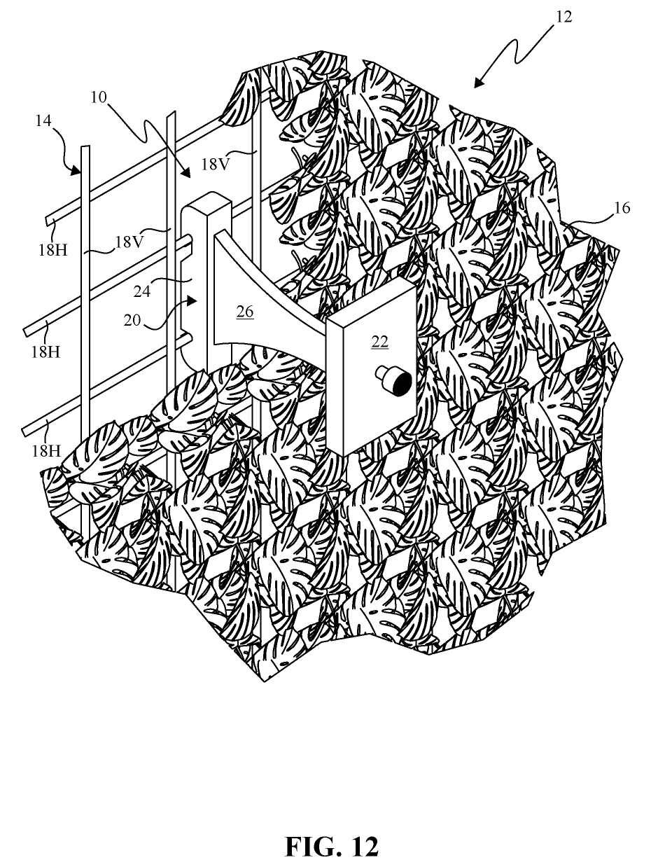

In operation, the male protrusion 28 and the female sockets 30/100 allow the support members 22 to be easily and quickly mounted the bracket stem 20/green wall 12 and swapped out for other support members 22 as may be necessary or desirable. For example, as illustrated in FIG. 8, a cup-shaped support member 22 for receiving and supporting beverage containers such as beer or soda bottles can be mounted to the bracket stem 20 by positioning the support member 22 adjacent to and above the male protrusion 28 and lowering the support member 22 towards and receiving the male protrusion 28 into the female socket 30/100 thereof. The cup-shaped support member 22 can then be replaced or swapped out for other types of support members 22 by lifting the cup-shaped support member 22 upwardly away from the male protrusion 28 and repeating the mounting process with, for example, a dish-shaped support member 22 for receiving and supporting candles (FIG. 9); a collar-shaped support member 22 for receiving and supporting a wine glass (FIG. 10); a vertical panel support member 22 having mounting holes for mounting signage to the green wall 12 (FIG. 11); and a vertical panel support member 22 having a mushroom-shaped protrusion 28 for hanging articles from the green wall 12 (FIG. 12).

Except as otherwise set forth herein, the components of the bracket system 10 are preferably formed from high-strength, light-weight materials such as, for example, plastic or resin materials including but not limited to high density polyethylene, nylon, acrylonitrile butadiene styrene (ABS), or other engineered polymers. Yet more preferably, except as otherwise set forth herein, the components of the bracket system 10 are integrally formed by casting, molding, machining, or otherwise shaping or forming from a unitary material.

While this invention has been described as having an exemplary design, the present invention may be further modified within the spirit and scope of this disclosure. For example, the male protrusion 28 and female sockets 30/100 are shown and described as trapezoidal or “dovetail”-shaped. However, it should be understood the male protrusion 28 and female sockets 30/100 can be other shapes and configurations, as may be necessary or desirable. Accordingly, this application is intended to cover any variations, uses, or adaptations of the invention using its general principles.

What is claimed is:

1. A bracket system mountable to a green wall metal support grid having a plurality of horizontal grid wires, the bracket system comprising:
a bracket stem having a base and a male protrusion, said base having one or more grid wire receiving openings; and
a support member having a female socket;
wherein the bracket stem is mounted to the metal support grid by receiving one or more grid wires into one or more of the grid wire receiving openings; and
wherein the support member is secured to the bracket stem by receiving the male protrusion into the female socket.

2. The bracket system of claim 1, wherein the stem base includes an upper grid wire receiving hook opening and a lower grid wire receiving slot.

3. The bracket system of claim 1, wherein the support member includes a perimeter side surface, and wherein the female socket is integrally formed adjacent the perimeter side surface.

4. The bracket system of claim 1, wherein the support member includes a perimeter side surface, a pair of socket side walls extending from the perimeter side surface, and a socket cap shelf extending between the socket side walls, and wherein the female socket is defined between the perimeter side surface, the socket side walls, and the socket cap shelf.

5. The bracket system of claim 1, wherein the male protrusion is trapezoidal or dovetail shaped.

6. The bracket system of claim 1, wherein the stem base includes an upper grid wire receiving hook opening and a lower grid wire receiving slot, and wherein the lower grid wire receiving slot includes one or more retaining ridges for capturing a grid wire therein.

7. The bracket system of claim 1, wherein the bracket stem and the support members are constructed from a plastic or resin material.

8. The bracket system of claim 1, further comprising vegetation supported on the metal support grid and wherein the bracket stem extends through the vegetation.

9. The bracket system of claim 8, wherein the male protrusion and the female socket are trapezoidal or dovetail shaped.

10. The bracket system of claim 9, wherein the stem base includes an upper grid wire receiving hook opening and a lower grid wire receiving slot.

11. The bracket system of claim 10, wherein the lower grid wire receiving slot includes one or more retaining ridges for capturing a grid wire therein.

12. The bracket system of claim 10, wherein the bracket stem and the support members are constructed from a plastic or resin material.

13. The bracket system of claim 10, wherein the bracket stem and the support members are constructed from one or more of a high density polyethylene, nylon, acrylonitrile butadiene styrene (ABS) and engineered polymers.

14. The bracket system of claim 1, wherein the male protrusion and the female socket are trapezoidal or dovetail shaped.

15. The bracket system of claim 14, wherein the stem base includes an upper grid wire receiving hook opening and a lower grid wire receiving slot.

16. The bracket system of claim 15, wherein the lower grid wire receiving slot includes one or more retaining ridges for capturing a grid wire therein.

17. The bracket system of claim 15, wherein the bracket stem and the support members are constructed from a plastic or resin material.

18. The bracket system of claim 15, wherein the bracket stem and the support members are constructed from one or more of a high density polyethylene, nylon, acrylonitrile butadiene styrene (ABS) and engineered polymers.

19. The bracket system of claim 1, wherein the bracket stem and the support members are constructed from one or more of a high density polyethylene, nylon, acrylonitrile butadiene styrene (ABS) and engineered polymers.
